(19) United States
(12) Patent Application Publication
(10) Pub. No.: US 2021/0268972 A1
(43) Pub. Date: Sep. 2, 2021

(54) WIRE HARNESS AND ATTACHMENT STRUCTURE FOR WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Satoshi YAMAMOTO, Mie (JP); Makoto HIGASHIKOZONO, Mie (JP); Hidetoshi ISHIDA, Mie (JP)

(21) Appl. No.: 17/253,385

(22) PCT Filed: Jun. 19, 2019
(86) PCT No.: PCT/JP2019/024258

§ 371 Date: Dec. 17, 2020

(30) Foreign Application Priority Data
Jul. 9, 2018 (JP) 2018-130062

(51) Int. Cl. B60R 16/02; H02G 11/00

(52) U.S. Cl. CPC B60R 16/0207; H02G 11/00

(57) ABSTRACT

A wire harness disclosed in the present specification is a wire harness that is attached to a seat surface frame and a back surface frame of a seat that is mounted in the vehicle, and the wire harness includes a wire W in which a core wire W1 is coated with an insulating coating W2, and a sheet-like base member including an attachment surface to which the plurality of wires W that are arranged side by side are fixed. A framework fixing portion that is fixed to the seat surface frame and the back surface frame in the state where the attachment surface of the base member is arranged on the seat surface frame side and the back surface frame side is provided in both side portions of a portion of the attachment surface of the base member on which the plurality of wires W are arranged.

### TECHNICAL FIELD

A technique disclosed in the present specification relates to a wire harness and an attachment structure for a wire harness.

### BACKGROUND

A wire harness disclosed in JP 2006-327424A (Patent Document 1 described below) is known as a wire harness routed in a vehicle seat that is mounted in vehicles, for example. This wire harness is routed in a seat surface, a seat back, and the like, and connects between electrical devices installed in the vehicle seat and a power supply source.

### PRIOR ART DOCUMENT

### Patent Document

Patent Document 1: JP 2006-327424A

### SUMMARY OF THE INVENTION

### Problems to be Solved

Incidentally, a wire harness described above is constituted by, for example, enveloping a wire bundle that bundles a plurality of wires with an exterior member such as a corrugated tube. Accordingly, when this kind of wire harness is routed in a framework in the seat, it is necessary to ensure a space for routing the wire harness in an outer circumference of the framework in the seat, in addition to a space for a cushion covering the framework, thus increasing a size of the seat. However, when the wire bundle is not covered by an exterior member, the wires and other members such as a cushion slide against each other, and thus the wires are worn.

The present specification discloses a technique that suppresses an increase in size of a seat and wear of a wire.

### Means to Solve the Problem

A technique disclosed in the present specification is a wire harness that is to be attached to a framework of a seat mounted in a vehicle, the wire harness including a wire in which a core wire is coated with an insulating coating, and a sheet-like base member that includes an attachment surface to which a plurality of the wires that are arranged side by side are fixed, and a framework fixing portion that is fixed to the framework in a state in which the attachment surface of the base member is arranged on the framework side is provided in a portion of the attachment surface of the base member that is different from a portion on which the plurality of wires are arranged.

Also, another technique disclosed in the present specification is an attachment structure of a wire harness, including a framework of a seat that is to be mounted in a vehicle, a wire in which a core wire is coated with an insulating coating, and a sheet-like base member that includes an attachment surface to which a plurality of the wires that are arranged side by side are fixed, and a portion of the attachment surface of the base member that is different from a portion on which the plurality of wires are arranged is fixed to the framework in a state in which the attachment surface of the base member is arranged on the framework side.

According to the wire harness configured as above, since the plurality of wires are arranged side by side and fixed to the base member, the height of the wire harness can be reduced, and an increase in size of the seat can be suppressed compared to the case where the plurality of wires are bundled and fixed. Also, by the wire harness being attached and fixed to the framework, the plurality of wires are covered by the base member from outside, which prevents the wires and the other members from sliding against each other. In this manner, it is possible to prevent the wires from wearing and being damaged.

Incidentally, a method using a flat cable can be conceived as a method for reducing the height of the wire harness. However, when the flat cable is used, the flat cable and the other members slide against each other, and eventually, the flat cable is damaged due to wear.

However, according to the configuration as described above, since the base member is arranged outward of the wires, it is highly effective in a location where the wire harness and the other members slide against each other.

The wire harness disclosed in the present specification may also be configured as follows.

The base member may also be formed in a shape along a routing path of the plurality of wires in the seat.

With this configuration, by simply fixing the base member to which the wires are fixed to the framework, the plurality of wires can be arranged along the routing path of the wires. Accordingly, it is possible to improve the workability of attaching the wire harness to the framework compared to the case where the wire harness is fixed to the seat while routing the wire harness.

Also, in the case of the routing path in which some of the wires are branched, the base member is branched and the wires are routed thereon, and thus, it is possible to make the wire harness smaller compared to a case where a flat cable to which a relay connector is attached to provide a branching portion is used, for example.

A configuration is also possible in which a cover base member that is fixed to a portion on the attachment surface side of the base member is further included such that the plurality of wires are interposed between the cover base member and the base member.

With this configuration, it is possible to protect the opposite side of the wires to the base member side by the cover base member. In this manner, when the wire harness is conveyed or the like before being attached to the framework, it is possible to prevent the wires from being damaged due to wear which is caused by the other members or other wire harnesses coming in contact with the wires.

A configuration is also possible in which the cover base member has a shape that conforms to an outer shape of the base member when the cover base member is fixed to the base member, and the framework fixing portion is fixed to the framework via the cover base member.

In the case where the cover base member is larger than the base member, for example, the cover base member protrudes outward of the outer shape of the base member, which makes the wire harness larger. However, with the above configuration, since the cover base member has a shape that conform to the outer shape of the base member, it is possible to prevent a case where the cover base member protrudes outward of the outer shape of the base member and the wire harness becomes larger.

Also, it is possible to reinforce the framework fixing portion of the base member by the cover base member, and the fixing strength of the wire harness to the framework can be improved.

A configuration is also possible in which the cover base member is formed by the same type of sheet-like member as the base member.

With this configuration, since it is possible to protect the opposite side of the wires to the base member side by the seat-like member that is the same type as the base member, the types of members can be reduced, and an increase in manufacturing costs of the wire harness can be suppressed compared to a case when the cover base member is formed by the member that is different type from the base member.

The cover base member may also be formed by a rigid plate-like member made of resin.

With this configuration, the wire harness with its shape maintained can be formed. In other words, since it is possible to attach the wire harness with its shape maintained along the seat framework, attachment workability can be further improved.

A configuration is also possible in which the seat includes a seat surface portion, and a back surface portion that is supported so as to be rotatable about a rotational shaft provided in the seat surface portion, the base member includes a first base portion that is arranged along the framework of the seat surface portion and the framework of the back surface portion, and a second base portion that is arranged between the framework of the seat surface portion and the framework of the back surface portion, and the cover base member is fixed to the first base portion.

With this configuration, even when the back surface portion rotates about the rotational shaft, since the cover base member is not attached to the second base portion, it is possible to cause the wire harness to follow the rotation of the back surface portion. In this manner, it is possible to apply the wire harness to the seat having the rotatable back surface portion while improving the workability of attaching the wire harness.

A configuration is also possible in which, in a state before the base member is fixed to the framework, the base member can be folded by the first base portion bending the second base portion.

When the shape of the wire harness to be attached to the framework of the seat is maintained as the above-described configuration, if the wire harness is in a state before being attached to the framework of the seat, the height of the wire harness may be increased and there is a concern that handling of the wire harness will be difficult.

However, with the above-described configuration, since it is possible to fold back the first base by bending the second base portion, it is possible to suppress a case where the height of the wire harness increases compared to the state before being folded, and to facilitate conveying work of the wire harness.

### Effect of the Invention

According to the technique disclosed in the present specification, it is possible to suppress wear of the wires as well as suppress an increase in size of the seat.

### BRIEF DESCRIPTION OF THE DRAWINGS

FIG. 1 is a perspective view showing a state in which a wire harness according to a first embodiment is fixed to a seat surface frame and a back surface frame as seen obliquely from the front.

FIG. 2 is a perspective view showing a state in which the wire harness according to the first embodiment is fixed to the seat surface frame and the back surface frame as seen obliquely from the back.

FIG. 3 is a perspective view showing a state in which the wire harness according to the first embodiment is fixed to the seat surface frame and the back surface frame as seen obliquely from below and the back.

FIG. 4 is an enlarged view of a relevant portion showing a state in which a plurality of wires are routed on the back surface frame in FIG. 3.

FIG. 5 is an enlarged view of a relevant portion showing a state in which the plurality of wires have been routed on the seat surface frame in FIG. 3.

FIG. 6 is a front view showing a state in which the wire harness according to the first embodiment is fixed to the seat surface frame and the back surface frame.

FIG. 7 is a back view showing the state in which the wire harness according to the first embodiment is fixed to the seat surface frame and the back surface frame.

FIG. 8 is a cross-sectional view taken along line VIII-VIII in FIG. 6 and a side view showing the state in which the wire harness according to the first embodiment is fixed to the seat surface frame and the back surface frame.

FIG. 9 is an enlarged view showing a region between the seat surface frame and the back surface frame in FIG. 8.

FIG. 10 is an enlarged view showing the wire harness arranged in the back surface portion in FIG. 8.

FIG. 11 is a perspective view showing a state before the wire harness according to the first embodiment is attached to the seat surface frame and the back surface frame.

FIG. 12 is a perspective view showing the wire harness in a folded state as seen obliquely from the front.

FIG. 13 is a plan view of the wire harness in the folded state.

FIG. 14 is a front view of the wire harness in the folded state.

FIG. 15 is a perspective cross-sectional view showing a state in which the wire harness according to the first embodiment are fixed to the back surface frame.

FIG. 16 is a cross-sectional view showing a state in which the wire harness according to the first embodiment is fixed to the back surface frame.

FIG. 17 is a perspective cross-sectional view showing a state in which a wire harness according to a second embodiment is fixed to the back surface frame.

FIG. 18 is a cross-sectional view showing a state in which the wire harness according to the second embodiment is fixed to the back surface frame.

FIG. 19 is a perspective cross-sectional view showing a state in which a wire harness according to a third embodiment is fixed to the back surface frame.

FIG. 20 is a cross-sectional view showing a state in which a wire harness according to the third embodiment is fixed to the back surface frame.

### DETAILED DESCRIPTION TO EXECUTE THE INVENTION

### First Embodiment

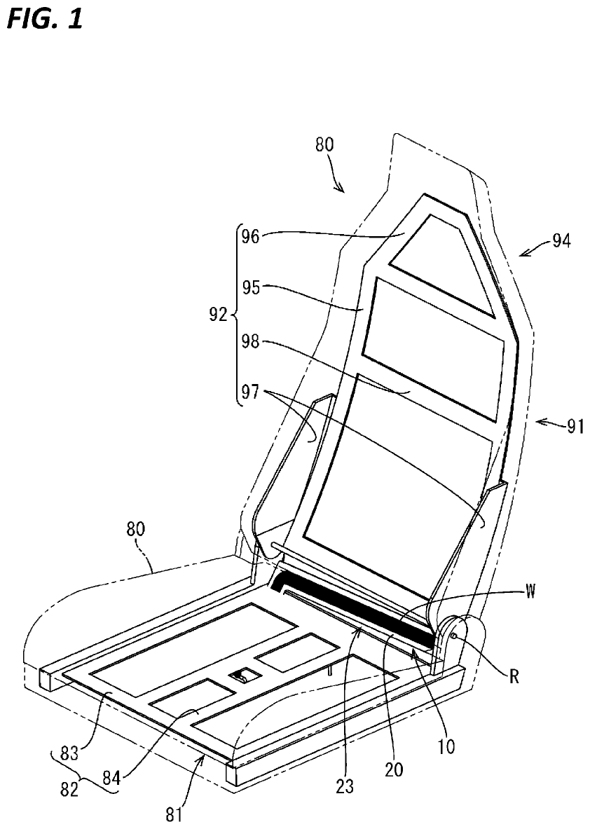

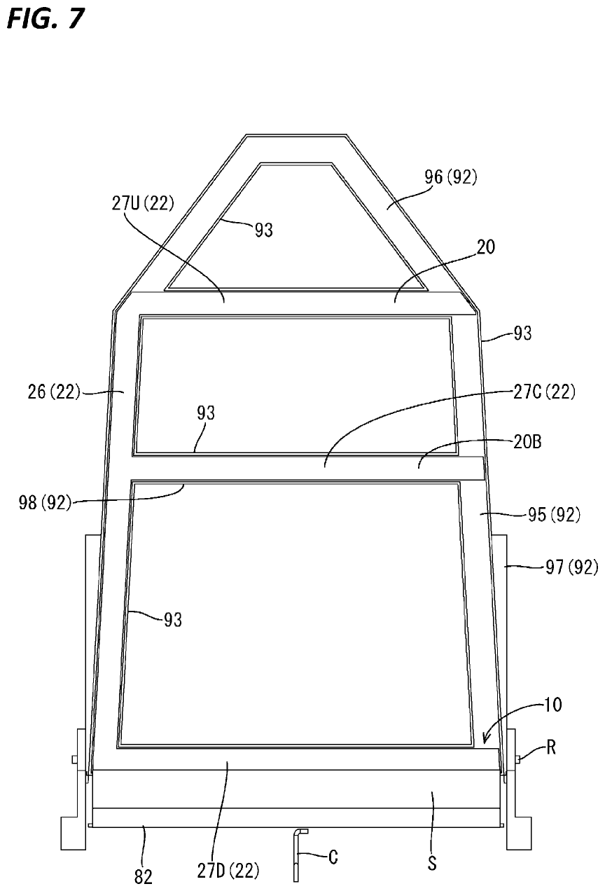

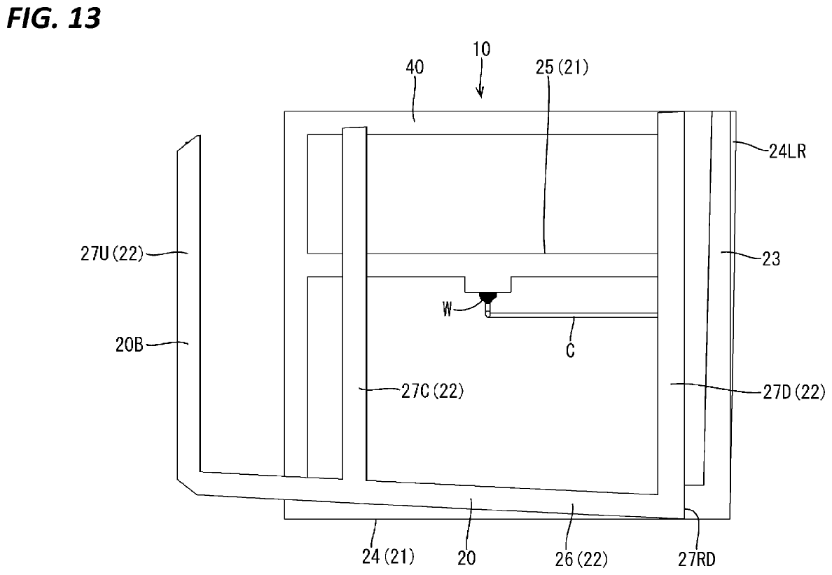

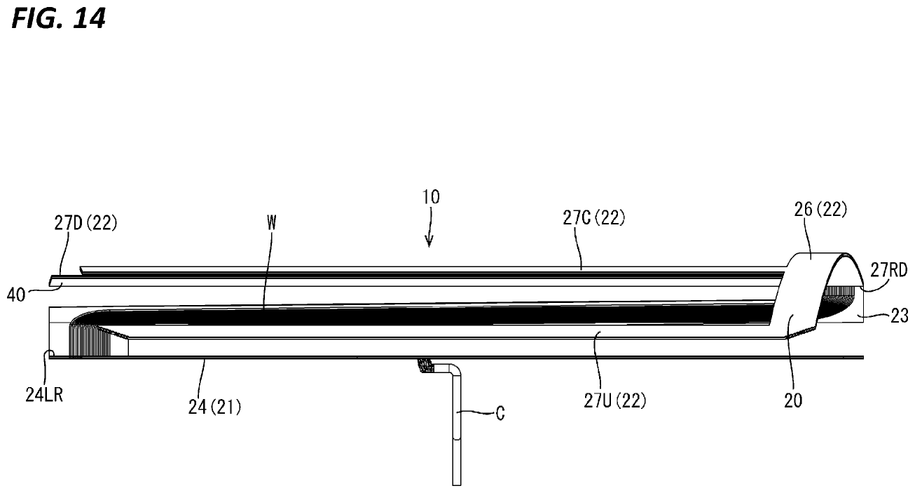

A first embodiment of the technique disclosed in the present specification will be described with reference to FIGS. 1 to 16.

The present embodiment exemplifies a wire harness 10 that is routed in a vehicle seat 80 that is mounted in a vehicle, the wire harness 10 being provided at a leading end of a multicore cable C that extends from a floor portion (not shown) of the vehicle, and is connected to an electrical device (not shown) that is mounted in the seat 80.

As shown in FIG. 1, the seat 80 includes a seat surface portion 81 on which an occupant can sit, and a back surface portion 91 on which the occupant sitting on the seat surface portion 81 rests his or her back.

The seat surface portion 81 is approximately rectangular, and a back surface portion 91 is provided at a rear end portion of the seat surface portion 81. Furthermore, the seat surface portion 81 includes a seat surface frame (an example of “framework”) 82, which is made of metal. A portion of the wire harness 10 is integrally attached and fixed to the seat surface frame 82, a seat surface cushion (not shown) formed by a polyurethane foam body is attached to the seat surface frame 82, and these are covered by a seat cover (not shown), thereby forming the seat surface portion 81.

As shown in FIGS. 1 to 3, the seat surface frame 82 has a shape in which a plate-like beam portion 84 that extends in the front-rear direction spans over a frame-like portion 83 that is shaped in an approximate rectangular flat plate-like frame, at the approximate center portion in the left-right direction of the frame-like portion 83. The seat surface frame 82 is formed by a rigid metal, and all the edges of the seat surface frame 82 are provided with protruding edge portions 85 that protrude downward.

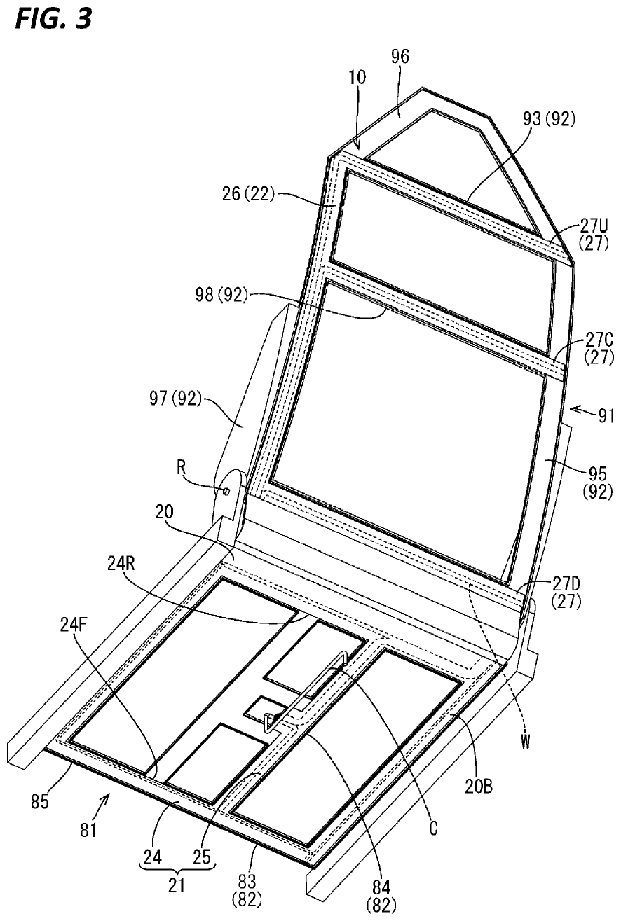

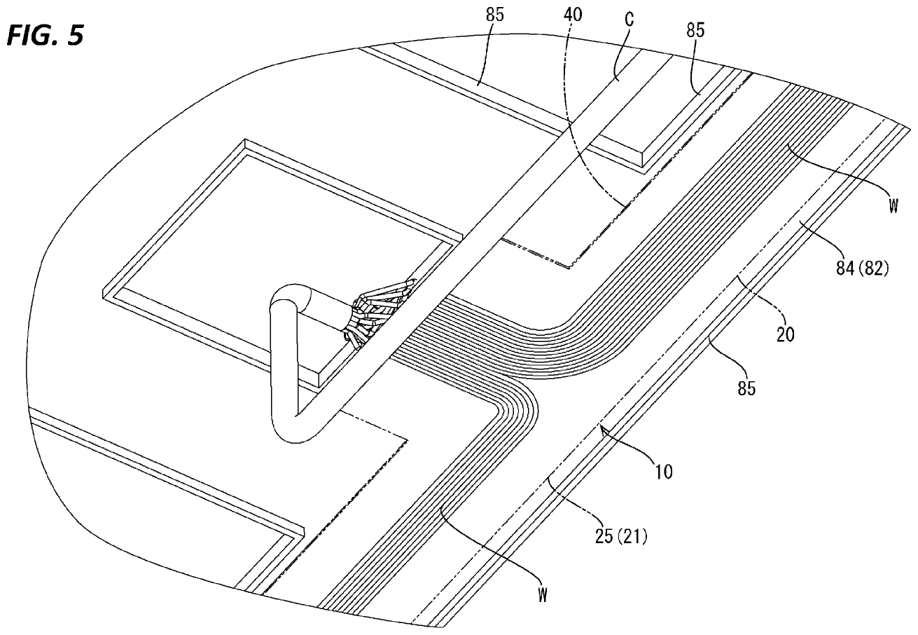

A not-shown seat surface cushion can be attached on the seat surface frame 82. As shown in FIGS. 3 and 5, a portion of the wire harness 10 can be attached to a region between the protruding edge portions 85 on the lower side of the seat surface frame 82. In addition, as shown in FIG. 3, a multicore cable C that extends from a floor portion of the vehicle toward the seat 80 is introduced into the approximate center portion in the front-rear direction of the beam portion 84 of the seat surface frame 82.

The multicore cable C is constituted by coating a plurality of wires W with an outer coating C2, and each of the wires W coated with the outer coating C2 is constituted by coating a core wire W1 made of a conductive metal with an insulating coating W2 made of a synthetic resin.

As shown in FIG. 1, the back surface portion 91 includes a back surface frame (an example of “framework”) 92 which is made of metal. The back surface frame 92 is formed by a rigid metal, and all the edges of the back surface frame 92 are provided with protruding edge portions 93 that protrude rearward. Furthermore, a portion of the wire harness 10 that is fixed to the seat surface frame 82 of the seat surface portion 81 is integrally attached and fixed to the back surface frame 92, a back surface portion cushion (not shown) formed by a polyurethane foam body is attached to the back surface frame 92, and these are covered by a back surface cover (not shown), thereby forming the back surface portion 91.

Furthermore, as shown in FIGS. 1 to 3 and FIGS. 6 to 8, the back surface portion 91 can rotate about a rotational shaft R that extends in the left-right direction and is a portion of a reclining mechanism that is provided at the rear end portion of the seat surface portion 81. A headrest portion 94 that supports a head portion of an occupant is provided on the upper portion of the back surface portion 91.

Accordingly, the rotational shaft R of the reclining mechanism is provided spanning from the seat surface portion 81 and the back surface portion 91.

Furthermore, the back surface frame 92 includes a frame body 95 that is shaped like a rectangular plate-like frame slightly elongated in the up-down direction, a head frame 96 provided at the upper portion of the frame body 95, and a pair of flat plate-like side frames 97 that are provided on both the left and right sides of the frame body 95.

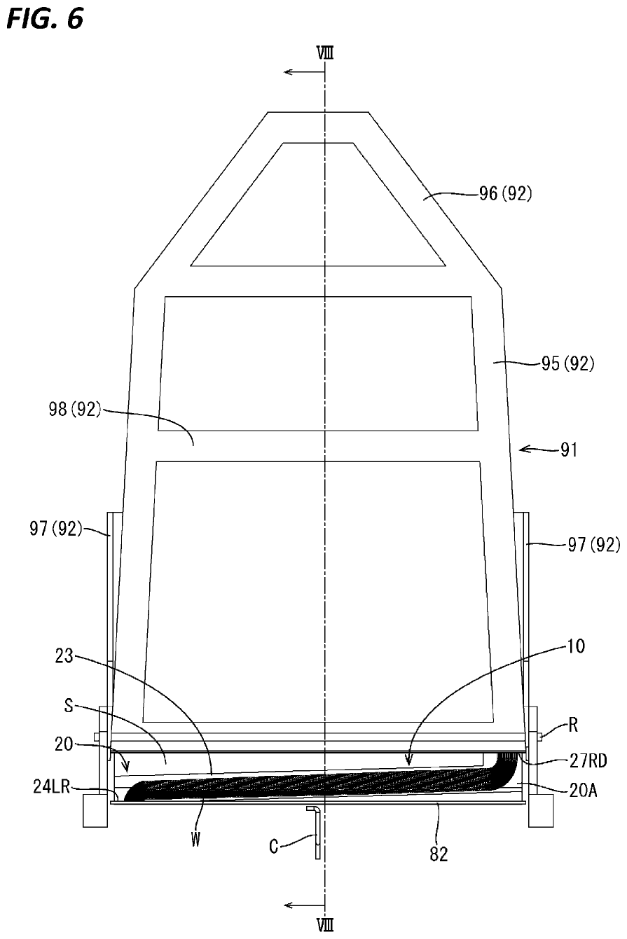

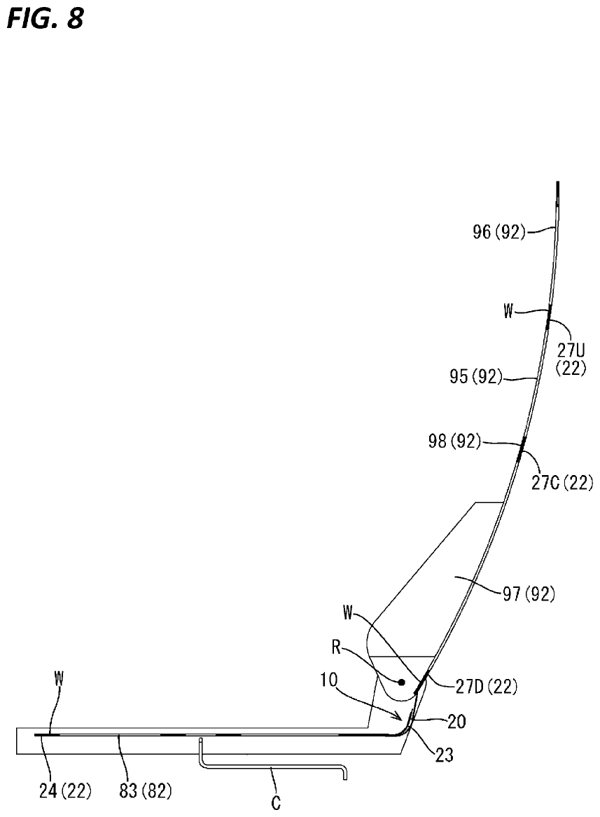

As shown in FIG. 8, the frame body 95 has a shape that increasingly bends frontward progressing downward. As shown in FIGS. 6 to 8, a support frame 98 that straightly bridges the frame body 95 in the left-right direction is provided at a location that is slightly upward of the approximate center portion in the up-down direction of the frame body 95.

A head frame 96 is a frame of the headrest portion 94 and shaped like an approximate triangular flat plate, and integrally provided at the upper end portion of the frame body 95.

As shown in FIG. 1, a pair of side frames 97 are formed protruding frontward from a side edge of the lower half of the frame body 95. The rotational shaft R of the seat surface portion 81 is inserted through the lower end portion of the pair of side frames 97 in the thickness direction, and the back surface frame 92 rotates about the rotational shaft R.

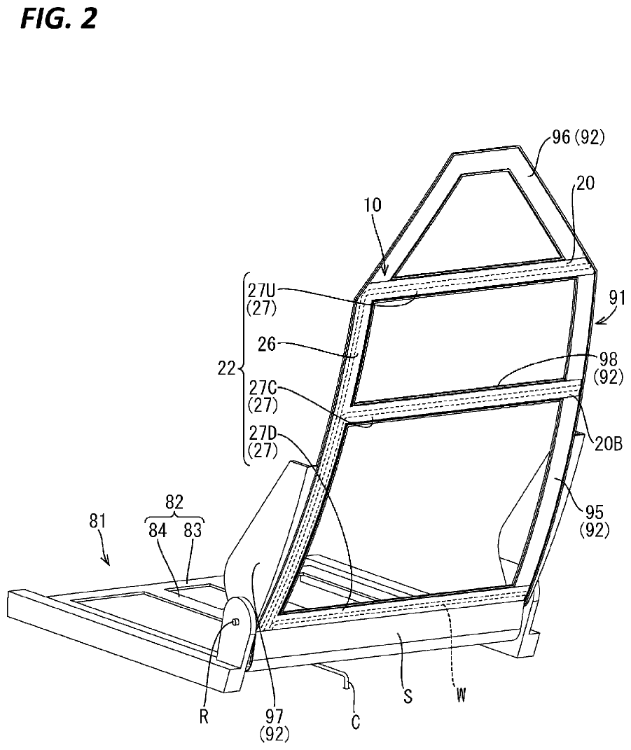

Also, a not-shown back surface cushion is configured to be attached to the front surfaces of the frame body 95 and the head frame 96. As shown in FIGS. 2 to 4, a portion of the wire harness 10 can be attached to the region between the protruding edge portions 93 on the rear surface of the frame body 95.

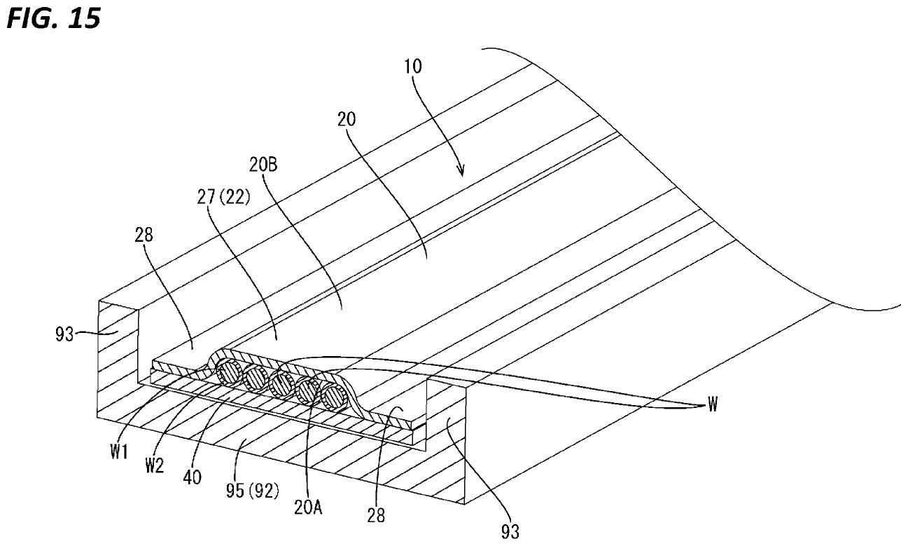

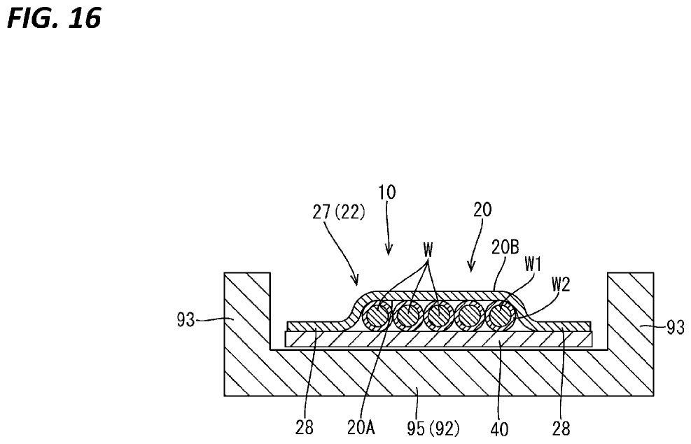

As shown in FIG. 5, the wire harness 10 is provided at the end portion of the multicore cable C, and as shown in FIGS. 15 and 16, the wire harness 10 is constituted by including the plurality of wires W that are exposed by stripping the outer coating C2 of the multicore cable C, and a base member 20 to which the wires W arranged side by side are fixed, and a cover base member 40 that covers the wires W fixed to the base member 20.

The base member 20 is formed by a sheet-like non-woven fabric. A non-woven fabric is a fabric formed by tangling or adhering fibers, and examples of a non-woven fabric include a fiber sheet, a web (a thin film-like sheet formed by only fibers), or a bat (a blanket-like fiber). In the present embodiment, the base member 20 is constituted by a fiber sheet. The base member 20 may also be a woven fabric formed by weaving natural fibers or synthetic fibers.

As shown in FIGS. 15 and 16, one side of the base member 20 is an attachment surface 20A to which the wires W are fixed, and another side of the base member 20, that is the opposite side to the attachment surface 20A, is an outer surface 20B that is arranged facing outward. The plurality of wires W are fixed to a region of the attachment surface 20A of the base member 20 excluding the side edge portions of the base member 20.

The wires W are fixed to the base member 20 by a known fixing method such as joining the wires W to the base member 20 by ultrasonic adhering or heat adhering, fixing the wires W to the base member 20 by using an adhesive, a pressure-sensitive adhesive or the like. The wires W fixed to the base member 20 are arranged side by side without a gap between the adjacent wires W.

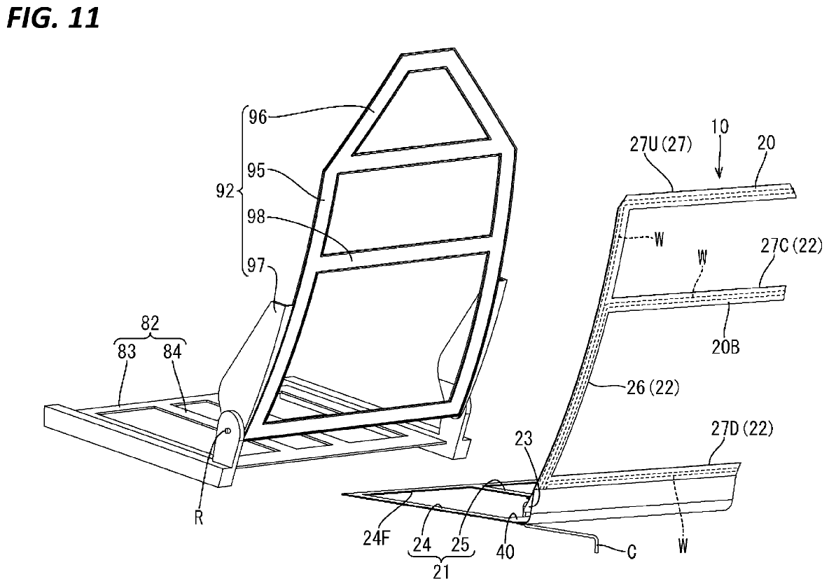

Furthermore, as shown in FIG. 11, the base member 20 includes a seat surface base portion 21 arranged on the lower surface of the seat surface frame 82, a back surface base portion 22 arranged on the rear surface of the frame body 95 of the back surface frame 92, and a flexible base portion 23 provided between the back surface frame 92 and the seat surface frame 82. Here, the seat surface base portion 21 and the back surface base portion 22 correspond to a first base portion, and the flexible base portion 23 corresponds to a second base portion.

As shown in FIG. 3, the seat surface base portion 21 includes a seat surface first routing portion 24 that is arranged on the lower surface of the frame-like portion 83 of the seat surface frame 82 and a seat surface second routing portion 25 that is arranged on the lower surface of the beam portion 84 of the seat surface frame 82, and a region formed by joining the seat surface first routing portion 24 and the seat surface second routing portion 25 matches the routing path of the wires W in the seat surface portion 81.

The seat surface first routing portion 24 is substantially shaped like a rectangular frame, and has a size that can be disposed between the protruding edge portions 85 of the frame-like portion 83. As shown in FIG. 3, the seat surface second routing portion 25 has a shape in which a front side edge 24F and a rear side edge 24R that are respectively arranged in front and rear of the seat surface first routing portion 24 are connected in the front-rear direction, and has a size that can be disposed between the protruding edge portions 85 of the beam portion 84.

Also, as shown in FIG. 5, in the seat surface second routing portion 25, a plurality of wires W of the multicore cable C introduced into the beam portion 84 of the seat surface frame 82 are arranged in a state of branching into two in the front-rear direction. Note that, in order to help understanding of the routing state of the wires W, the base member 20 and the cover base member 40 are not shown in FIG. 5.

As shown in FIG. 3, the wires W arranged in the seat surface second routing portion 25 extend along the seat surface second routing portion 25 to the front end portion and the rear end portion of the seat surface second routing portion 25, and then are drawn out toward the seat surface first routing portion 24. The wires W drawn out from the seat surface second routing portion 25 are arranged in the seat surface first routing portion 24, and some of the wires W are arranged along the seat surface first routing portion 24 and then connected to an electrical device (not shown) that is installed in the seat surface portion 81. Also, other wires W that are not connected to the electrical device are arranged along the seat surface first routing portion 24, and extend to a left side rear end portion 24LR of the seat surface first routing portion 24.

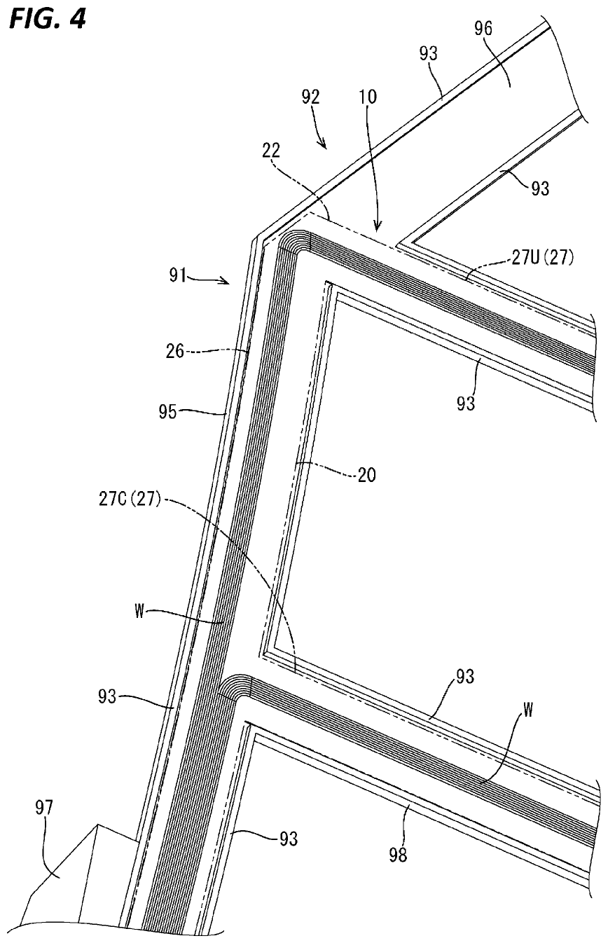

As shown in FIGS. 3 and 4, the back surface base portion 22 includes a back surface first routing portion 26 that is arranged on the rear surface of the right side edge of the frame body 95 of the back surface frame 92, and a plurality of back surface second routing portions 27 that are arranged on the rear surface of a portion that extends in the left-right direction of the frame body 95, and a region formed by the back surface first routing portion 26 and the back surface second routing portions 27 matches the routing path of the wires W on which the wires W drawn out from the seat surface portion 81 are routed in the back surface portion 91.

The back surface first routing portion 26 is shaped like a band that linearly extends in the up-down direction, and has a size that can be disposed between the protruding edge portions 93 at the right side edge of the frame body 95.

The back surface second routing portions 27 extend rightward from the right side edge of the back surface first routing portion 26, and provided at three locations in total, namely, an upper end location and an lower end location of the back surface first routing portion 26, and a central location that is slightly upward of an approximate central portion in the up-down direction of the back surface first routing portion 26. Also, the back surface second routing portions 27 have a size that can be disposed between the protruding edge portions 93 of the frame body 95 and the support frame 98, and the back surface second routing portion 27U at the upper end location can be attached to the rear surface of the upper edge of the frame body 95, the back surface second routing portion 27D at the lower end location can be attached to the rear surface of the lower edge of the frame body 95, and the back surface second routing portion 27C at the central location can be attached to the rear surface of the support frame 98.

Also, the plurality of wires W extending from a flexible base portion 23, which will be described later, are arranged in the back surface first routing portion 26, and as shown in FIGS. 2 and 3, some of the routed wires W are branched rightward from the lower end portion of the back surface first routing portion 26 and arranged along the back surface second routing portion 27D at the lower end location, and then connected to an electrical device (not shown).

As shown in FIGS. 2 to 4, the remaining wires W of the plurality of wires W arranged in the back surface first routing portion 26 are arranged along the back surface first routing portion 26 so as to straightly extend upward from the lower end portion of the back surface first routing portion 26, and some of the remaining wires W are branched rightward from a location that is slightly upward of the approximate central portion in the up-down direction of the back surface first routing portion 26. Note that, in order to help understanding of the routing state of the wires W, the base member 20 and the cover base member 40 are not shown in FIG. 4.

Some of wires W that are branched rightward from the approximate central portion in the up-down direction of the back surface first routing portion 26 are arranged along the back surface second routing portion 27C at the central location, and then connected to an electrical device (not shown) that is arranged at the approximate central portion in the up-down direction of the back surface portion 91. The wires W that extend to the upper end of the back surface first routing portion 26 are bent rightward and arranged along the back surface second routing portion 27U at the upper end location, and then connected to an electrical device (not shown) arranged in the periphery of the headrest portion 94.

Also, as shown in FIGS. 2, 3, and 10, a protection sheet S shaped like a sheet elongated in the left-right direction is attached to a region between the seat surface frame 82 and the frame body 95 of the back surface frame 92.

The protection sheet S is provided joining the lower end edge portion of the frame body 95 of the back surface frame 92 and the rear end edge portion of the seat surface frame 82, and the flexible base portion 23 is arranged in front of the protection sheet S.

As shown in FIGS. 1, 6, and 12, the flexible base portion 23 slightly extends out upwardly progressing rearward in an arc-like shape from the left side rear end portion 24LR of the seat surface first routing portion 24, and then gently extends out obliquely right upward, and the right end portion of the flexible base portion 23 extends out upward. The flexible base portion 23 integrally connects the right side lower edge portion 27RD of the back surface second routing portion 27D at the lower end location of the back surface base portion 22 and the left side rear end portion 24LR of the seat surface first routing portion 24 of the seat surface base portion 21 in an oblique direction.

The wires W drawn in from the left side rear end portion 24LR of the seat surface first routing portion 24 of the seat surface base portion 21 are arranged in the flexible base portion 23, and the wires W are arranged along the flexible base portion 23 from the left side rear end portion 24LR of the seat surface first routing portion 24 to the right side lower edge portion 27RD of the back surface second routing portion 27D at the lower end location of the back surface base portion 22.

Accordingly, unlike the seat surface base portion 21 and the back surface base portion 22, the flexible base portion 23 can easily bend. The wires W of the multicore cable C extending from the floor portion of the vehicle are arranged along the seat surface base portion 21, the flexible base portion 23, and the back surface base portion 22, and then connected to an electrical device installed in the seat 80.

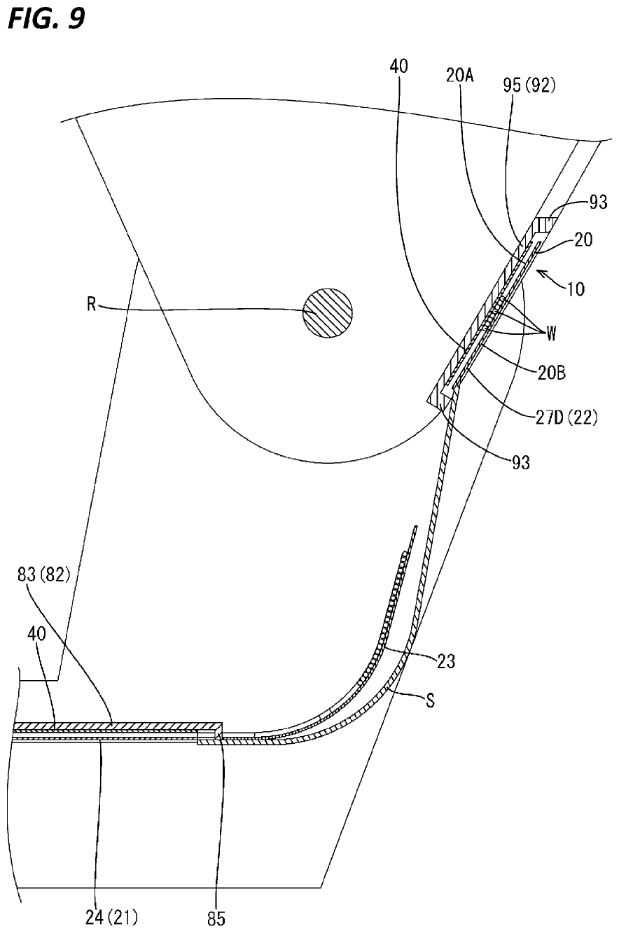

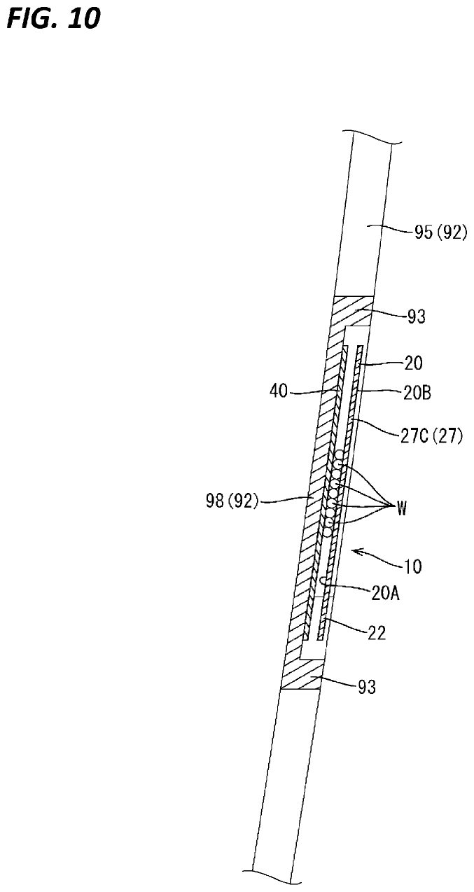

Also, as shown in FIGS. 15 and 16, the locations on the both sides of the region of the attachment surfaces 20A of the seat surface base portion 21 and the back surface base portion 22 of the base member 20, to which the wires W are fixed, are framework fixing portions 28 that are fixed to the seat surface frame 82 and the back surface frame 92 via the cover base member 40 in the state where the attachment surface 20A of the base member 20 is arranged on the seat surface frame 82 side or the back surface frame 92 side, and the outer surface 20B of the base member 20 arranged outside. Note that, as shown in FIGS. 15 and 16, the framework fixing portions 28 are fixed to the seat surface frame 82 and the back surface frame 92 via the cover base member 40 by the base member 20 being arranged along the wires W, but the portions in which the base member 20 is arranged along the wires W are not shown in FIGS. 9 and 10.

The framework fixing portion 28 is approximately the entire range of the both sides of the regions of the seat surface base portion 21 and the back surface base portion 22 to which the wires W are fixed. The framework fixing portion 28 is fixed to the seat surface frame 82 and the back surface frame 92 by a known fixing method such as joining the cover base member 40 to the seat surface frame 82 and the back surface frame 92 by ultrasonic welding or heat welding, or fixing the cover base member 40 using an adhesive or a pressure-sensitive adhesive. Also, a method in which resin clips or the like into which the base member 20 and the cover base member 40 penetrate are engaged with the seat surface frame 82 and the back surface frame 92 may also be used to fix the framework fixing portion 28.

The cover base member 40 is formed by processing a rigid plate-like member made of a synthetic resin. The cover base member 40 is formed slightly smaller than the base member 20, but has an outer shape that is similar to the outer shape of the base member 20. As shown in FIGS. 15 and 16, when the cover base member 40 is fixed to the framework fixing portion 28 of the base member 20, the base member 20 is aligned with the side portion of the wires W, and the framework fixing portion 28 is fixed to the cover base member 40.

Accordingly, although the cover base member 40 is formed slightly smaller than the base member 20, when the cover base member 40 is fixed to the base member 20, as shown in FIGS. 15 and 16, the side portion of the cover base member 40 conform to the side portion of the base member 20, and thus the cover base member 40 can be prevented from protruding outward from the outer shape of the base member 20.

Note that, the cover base member 40 is fixed to the framework fixing portion 28 of the base member 20 by a known fixing method such as joining the cover base member 40 to the base member 20 by ultrasonic welding or heat welding, or fixing the cover base member 40 to the base member 20 by using an adhesive or a pressure-sensitive adhesive.

Also, as shown in FIG. 11, the seat surface base portion 21 and the back surface base portion 22 can maintain their shapes due to the rigidity of the cover base member 40 by the cover base member 40 being fixed, making it possible to maintain the wire W in the shape of the routing paths in the seat surface portion 81 and the back surface portion 91.

The present embodiment is configured as above, and next, the operations and effects of the wire harness 10 will be described.

In the case where the wire harness routed in the seat 80 mounted in the vehicle is constituted by, for example, coating the wire bundle formed by bundling the plurality of wires with the exterior member such as a corrugated tube, when the wire harness is routed in the frame inside the seat, it is necessary to ensure a region for routing the wire harness in the outer periphery of the frame in the seat, in addition to a cushion for covering the frame, and thus the size of the seat is increased. However, if the wire bundle is not coated with an exterior member, the wire bundle and other members such as a cushion slide against each other, which wears the wires.

In view of this, according to the wire harness 10 according to the present embodiment, as shown in FIGS. 15 and 16, since the attachment surfaces 20A of the seat surface base portion 21 and the back surface base portion 22 of the base member 20 to which the plurality of wires W arranged side by side are fixed are arranged on the seat surface frame 82 side or the back surface frame 92 side, and the framework fixing portion 28 is fixed to the seat surface frame 82 and the back surface frame 92 via the cover base member 40 in the state where the outer surface 20B of the base member 20 is arranged outside, it is possible to reduce the height of the wire harness 10 and prevent the wires W and other members from sliding against each other.

In this manner, it is possible to reduce a space in the seat 80 in which the wire harness 10 is arranged, suppress an increase in size of the seat 80, and suppress damage to the wires W due to wear.

Incidentally, in order to reduce the height of the wire harness, it is conceivable to use a method using a flat cable. However, when the flat cable is used, the flat cable and the other members slide against each other, and eventually, the flat cable is damaged due to wear.

In view of this, according to the configuration as described above, since the base member 20 is arranged outside of the wires W, it is very effective in a location where the wire harness 10 and the other members slide against each other.

Furthermore, according to the present embodiment, the seat surface base portion 21 and the back surface base portion 22 of the base member 20 are aligned with the routing paths of the wires W in the seat surface portion 81 and the back surface portion 91. As shown in FIG. 11, due to the rigidity of the cover base member 40 fixed to the base member 20, the shapes of the seat surface base portion 21 and the back surface base portion 22 are maintained, and thus by simply attaching and fixing the wire harness 10 to the seat surface frame 82 and the back surface frame 92, it is possible to arrange the wires W along the routing paths in the seat surface portion 81 and the back surface portion 91.

In this manner, it is possible to significantly improve the workability of attaching the wire harness 10 to the frame and reduce mistakes such as attaching the wire harness 10 to wrong locations, compared to a case in which the wire harness is routed along and fixed to the seat surface frame 82 and the back surface frame 92 of the seat 80, as in the conventional manner

Furthermore, in the case of the routing path formed by some of the wires W of the plurality of wires W being branched, as shown in FIGS. 4 and 5, since the base member 20 is branched and the wires W are routed, it is possible to reduce the size of wire harness 10 compared to a case of a flat cable to which the relay connector is attached to provide a branching portion, for example.

Furthermore, since the location of the wires W on the side opposite to the base member 20 side is protected by the cover base member 40, when the wire harness 10 in the state before being attached to the seat surface frame 82 and the back surface frame 92 is to be conveyed, for example, it is possible to prevent a case where the other members and other wire harnesses come in contact with the wires W and the wires W are worn.

Incidentally, in the wire harness 10 of the present embodiment, the rigid cover base member 40 is fixed to the base member 20, and thus the shapes of the seat surface base portion 21 and the back surface base portion 22 can be maintained. However, if the wire harness 10 is kept in the shape of the seat 80, there is a concern about the trackability of the wire harness 10 in the case where the back surface portion 91 is rotated with respect to the seat surface portion 81 using the reclining mechanism of the seat 80. Also, since the height of the wire harness 10 increases, there is a concern about inconvenience in conveying the wire harness 10.

In view of this, in the wire harness 10 of the present embodiment, the cover base member 40 is fixed to the seat surface base portion 21 fixed to the seat surface frame 82 of the seat surface portion 81 and the back surface base portion 22 fixed to the back surface frame 92 of the back surface portion 91, but as shown in FIG. 9, the cover base member 40 is not fixed to the flexible base portion 23 that connects the seat surface base portion 21 and the back surface base portion 22, and thus when the back surface portion 91 is rotated with respect to the seat surface portion 81 using the reclining mechanism of the seat 80, the wire harness 10 can be caused to follow the rotation of the back surface portion 91 by the flexible base portion 23 being bent.

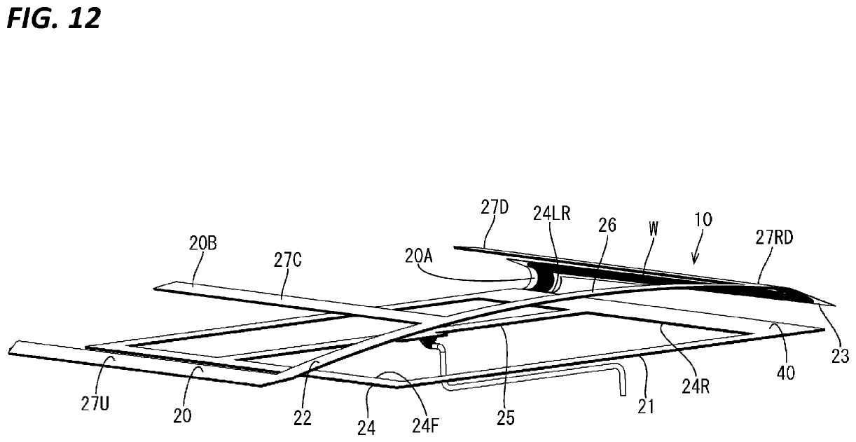

Furthermore, as shown in FIGS. 12 to 14, it is possible to fold the wire harness 10 by bending the flexible base portion 23 such that the back surface base portion 22 approaches the seat surface base portion 21. In this manner, compared to the wire harness 10 in an unfolded state, it is possible to suppress an increase in height of the wire harness 10, and facilitate a conveying task and the like of the wire harness 10.

As described above, the wire harness 10 of the present embodiment is the wire harness 10 that is attached to the seat surface frame 82 and the back surface frame 92 of the seat 80 that is mounted in the vehicle, and the wire harness 10 includes the wires W each formed by coating the core wire W1 with the insulating coating W2, and the sheet-like base member 20 including the attachment surface 20A to which the plurality of wires W arranged side by side are fixed. The framework fixing portion 28 that is fixed to the seat surface frame 82 and the back surface frame 92 in the state where the attachment surface 20A of the base member 20 is arranged on the seat surface frame 82 side and the back surface frame 92 side is provided in the both side portions of a portion of the attachment surface 20A of the base member 20 on which the plurality of wires W are arranged.

In other words, according to the wire harness 10 of the present embodiment, the plurality of wires W are covered by the base member 20 from outside, and thus it is possible to prevent the wires W and the other members such as a cushion from sliding against each other. In this manner, compared to the case where the plurality of wires are bundled and fixed, the height of the wire harness 10 can be reduced and damage to the wires W due to wear can be prevented.

Also, since the base member 20 has a shape formed along a routing path of the wires W in the seat 80, it is possible to arrange the wires W along the routing path by simply fixing the base member 20 to which the wires W are fixed to the seat surface frame 82 and the back surface frame 92. In this manner, it is possible to improve the workability of attaching the wire harness 10 to the seat surface frame 82 and the back surface frame 92.

Furthermore, according to the present embodiment, since the cover base member 40 that is fixed to a portion on the attachment surface 20A side of the base member 20 so as to interpose the wires W with the base member 20 is further provided, it is possible to protect the opposite side of the wires W to the base member 20 side by the cover base member 40.

Furthermore, the cover base member 40 has a shape that conforms to the outer shape of the base member 20 when fixed to the base member 20, and the framework fixing portion 28 is fixed to the seat surface frame 82 and the back surface frame 92 via the cover base member 40. In other words, for example, if the cover base member is larger than the base member, the cover base member protrudes outward from the outer shape of the base member.

However, according to the present embodiment, in a state where the cover base member 40 is fixed to the framework fixing portion 28 of the base member 20, since the cover base member 40 has a shape that conforms to the outer shape of the base member 20, the cover base member 40 is prevented from protruding outward from the outer circumferential edge of the base member 20, making it possible to suppress an increase in size of the wire harness 10. Furthermore, since the framework fixing portion 28 of the base member 20 can be reinforced by the cover base member 40, it is possible to improve the fixing strength of the wire harness 10 with respect to the seat surface frame 82 and the back surface frame 92.

Furthermore, since the cover base member 40 is formed by a rigid plate-like member made of a synthetic resin, the wire harness 10 with its shape kept can be formed, making it possible to further improve the attachment workability.

Furthermore, according to the present embodiment, the seat 80 includes the seat surface portion 81, the back surface portion 91 that is supported rotatably about the rotational shaft R provided in the seat surface portion 81, and the base member 20 includes the seat surface base portion 21 that is arranged along the seat surface frame 82 of the seat surface portion 81 and the back surface base portion 22 arranged along the back surface frame 92 of the back surface portion 91, and a flexible base portion 23 arranged between the seat surface frame 82 of the seat surface portion 81 and the back surface frame 92 of the back surface portion 91, and the cover base member 40 is fixed to the seat surface base portion 21 and the back surface base portion 22.

In other words, even if the back surface portion 91 rotates about the rotational axis R with respect to the seat surface portion 81, since the cover base member 40 is not attached to the flexible base portion 23, it is possible to cause the wire harness 10 to follow the rotation of the back surface portion 91.

Furthermore, in the state before being fixed to the seat surface frame 82 and the back surface frame 92, the base member 20 can be folded by the seat surface base portion 21 and the back surface base portion 22 bending the flexible base portion 23. In other words, in the wire harness 10 of the present embodiment, since it is possible to fold the wire harness 10 by bending the flexible base portion 23, it is possible to suppress an increase in height of the wire harness 10 compared to the unfolded state.

### Second Embodiment

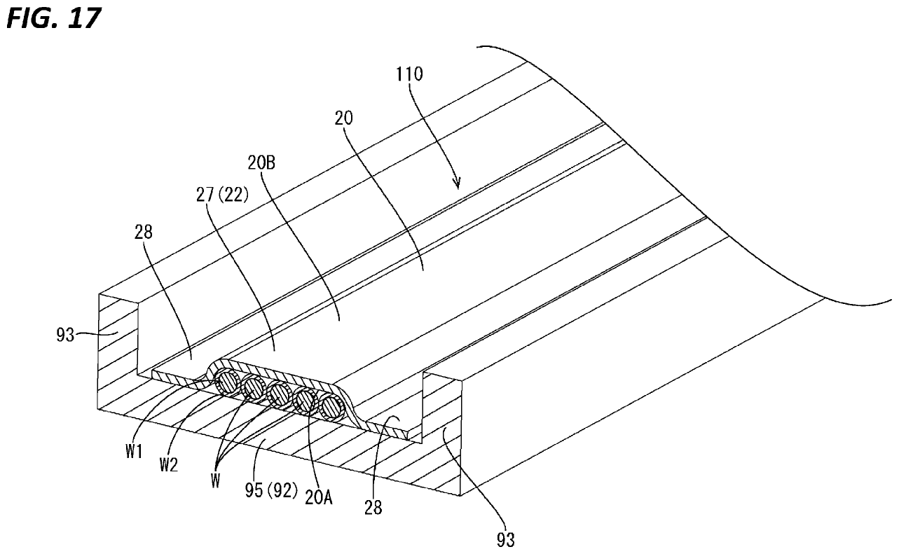

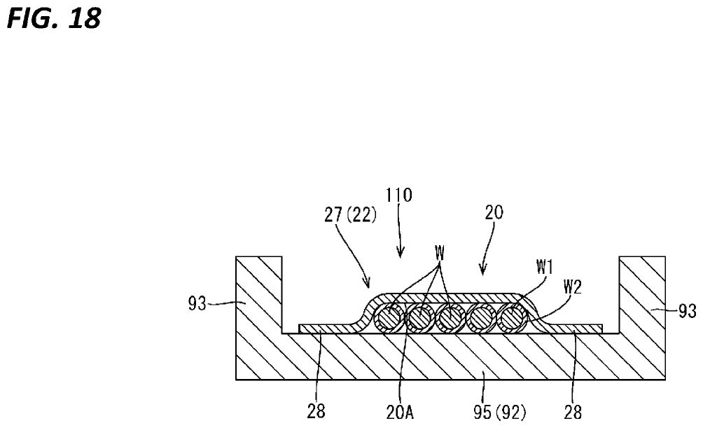

Next, a second embodiment will be described with reference to FIGS. 17 and 18.

In a wire harness 110 of the second embodiment, the cover base member 40 of the first embodiment has been omitted, and since descriptions of the configurations, operations, and effects that are common to the first embodiment are redundant, such descriptions will be omitted. Furthermore, the structures similar to the first embodiment will be given the same reference numerals.

As shown in FIGS. 17 and 18, in the wire harness 110 of the second embodiment, the framework fixing portion 28 of the base member 20 is directly fixed to the seat surface frame 82 and the back surface frame 92. The framework fixing portion 28 is fixed to the seat surface frame 82 and the back surface frame 92 by a known fixing method such as joining the framework fixing portion 28 to the seat surface frame 82 and the back surface frame 92 by ultrasonic welding or heat welding, or fixing the framework fixing portion 28 using an adhesive or a pressure-sensitive adhesive. Also, a method in which a resin clip or the like into which the framework fixing portion 28 of the base member 20 penetrates is engaged with the seat surface frame 82 and the back surface frame 92 may also be used to fix the framework fixing portion 28.

### Third Embodiment

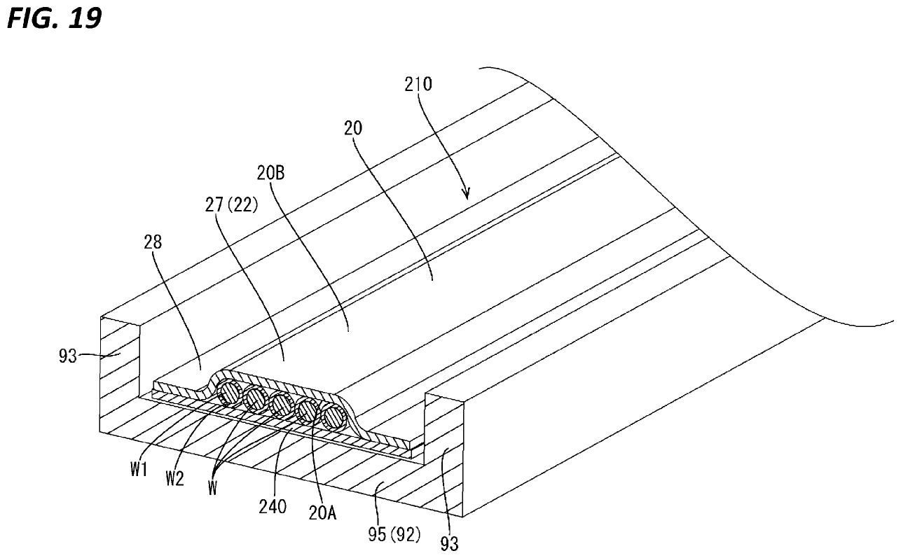

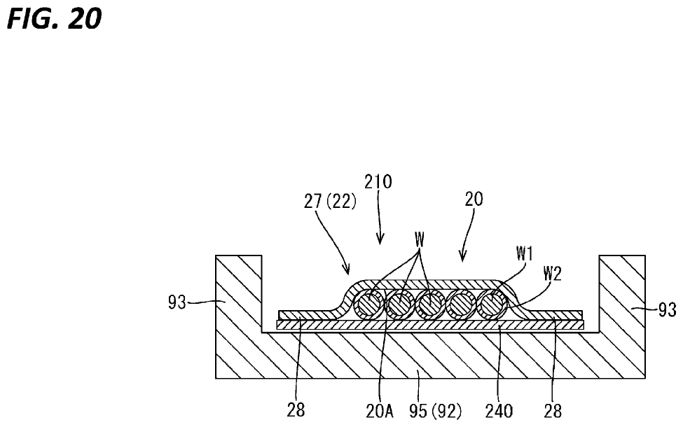

Next, a third embodiment will be described with reference to FIGS. 19 and 20. In a wire harness 210 of the third embodiment, the cover base member 40 of the first embodiment has been changed, and since descriptions of the configurations, operations, and effects that are common to the first embodiment are redundant, such descriptions will be omitted. Furthermore, the structures similar to the first embodiment will be given the same reference numerals.

As shown in FIGS. 19 and 20, the cover base member 240 of the second embodiment is formed by the same type of sheet-like nonwoven fabric as the base member 20, a cover base member 240 is fixed to the framework fixing portion 28 of the base member 20 by ultrasonic welding or heat welding, or by adhering to the framework fixing portion 28 of the base member 20 by an adhesive or a pressure-sensitive adhesive.

The framework fixing portion 28 of the base member 20 is fixed, via the cover base member 240, to the seat surface frame 82 and the back surface frame 92 by welding by ultrasonic welding or heat welding, by adhering with an adhesive or a pressure-sensitive adhesive, or by using a resin clip into which the framework fixing portion 28 and the cover base member 240 penetrate, or the like.

In other words, the wire harness 210 of the present third embodiment cannot maintain its shape, but since the base member 20 and the cover base member 240 are formed in shapes along the routing path of the plurality of wires W in the seat 80, it is possible to arrange the wires W along the routing path by simply fixing the base member 20 and the cover base member 240 to the seat surface frame 82 and the back surface frame 92. In this manner, it is possible to improve the workability of attaching the wire harness 10 to the seat surface frame 82 and the back surface frame 92.

In other words, since the cover base member 240 of the present embodiment is formed by the same type of sheet-like member as the base member 20, for example, compared to the case in which the cover base member is formed by a different type of member from the base member, the types of members can be reduced and an increase in manufacturing cost of the wire harness 210 can be suppressed.

### Other embodiments

The technique disclosed in the present specification is not limited to the embodiments described according to the above description and the drawings, and for example, various modes as follows are also encompassed therein.

(1) In the above-described embodiment, the plurality of wires W are fixed to the base member 20 by welding, adhering or the like. However, there is no limitation to this, and the wires may also be fixed to the base member by sewing with a thread-like member or the like.

(2) In the above-described embodiment, the base member 20 includes the seat surface base portion 21, the back surface base portion 22, and the flexible base portion 23. However, there is no limitation to this, and the base member may also be constituted by simply the seat surface base portion in a case where the wires are routed only in the seat surface or the like.

(3) In the above-described embodiment, the frame of the seat 80 is formed by metal. However, there is no limitation to this, and the frame of the seat may also be formed by a synthetic resin, a fiber-reinforced plastic, or the like.

### LIST OF REFERENCE NUMERALS

10, 110, 110: Wire harness

20: Base member

20A: Attachment surface

21: Seat surface base portion (an example of “first base portion”)

22: Back surface base portion (an example of “first base portion”)

23: A flexible base portion (an example of “second base portion”)

28, 228: Framework fixing portion

40, 240: Cover base member

80: Seat

81: Seat surface portion

82: Seat surface frame (an example of “framework”)

91: Back surface portion

92: Back surface frame (an example of “framework”)

R: Rotational axis

W: Wire

W1: Core wire

W2: Insulating coating

1. A wire harness that is to be attached to a framework of a seat mounted in a vehicle, the wire harness comprising:
a wire in which a core wire is coated with an insulating coating; and
a sheet-like base member that includes an attachment surface to which a plurality of the wires that are arranged side by side are fixed,
wherein a framework fixing portion that is fixed to the framework in a state in which the attachment surface of the base member is arranged on the framework side is provided in a portion of the attachment surface of the base member that is different from a portion on which the plurality of wires are arranged.

2. The wire harness according to claim 1,
wherein the base member is formed in a shape along a routing path of the plurality of wires in the seat.

3. The wire harness according to claim 1, further comprising:
a cover base member that is fixed to a portion on the attachment surface side of the base member such that the plurality of wires are interposed between the cover base member and the base member.

4. The wire harness according to claim 3,
wherein the cover base member has a shape that conforms to an outer shape of the base member when the cover base member is fixed to the base member, and
the framework fixing portion is fixed to the framework via the cover base member.

5. The wire harness according to claim 3,
wherein the cover base member is formed by the same type of sheet-like member as the base member.

6. The wire harness according to claim 3,
wherein the cover base member is formed by a rigid plate-like member made of resin.

7. The wire harness according to claim 6,
wherein the seat includes a seat surface portion, and a back surface portion that is supported so as to be rotatable about a rotational shaft provided in the seat surface portion,
the base member includes a first base portion that is arranged along the framework of the seat surface portion and the framework of the back surface portion, and a second base portion that is arranged between the framework of the seat surface portion and the framework of the back surface portion, and
the cover base member is fixed to the first base portion.

8. The wire harness according to claim 7,
wherein, in a state before the base member is fixed to the framework, the base member can be folded by the first base portion bending the second base portion.

9. An attachment structure of a wire harness, comprising:
a framework of a seat that is to be mounted in a vehicle;
a wire in which a core wire is coated with an insulating coating; and
a sheet-like base member that includes an attachment surface to which a plurality of the wires that are arranged side by side are fixed,
wherein a portion of the attachment surface of the base member that is different from a portion on which the plurality of wires are arranged is fixed to the framework in a state in which the attachment surface of the base member is arranged on the framework side.
